(19) United States
(12) Patent Application Publication
(10) Pub. No.: US 2024/0080686 A1
(43) Pub. Date: Mar. 7, 2024

(54) CLASSIFICATION OF INDOOR-TO-OUTDOOR TRAFFIC AND USER EQUIPMENT DISTRIBUTION

(71) Applicant: Telefonaktiebolaget LM Ericsson (publ), Stockholm (SE)

(72) Inventors: Rohit CHANDRA, Solna (SE); Brahim BELAOUCHA, Nacka (SE); Tomas LUNDBORG, Hässelby (SE); Gunther AUER, Göteborg (SE); Bengt MÄLER, Täby (SE)

(21) Appl. No.: 18/263,414

(22) PCT Filed: Feb. 1, 2021
(86) PCT No.: PCT/SE2021/050073

§ 371 Date: Jul. 28, 2023

(51) Int. Cl. H04W 24/08; H04W 24/02; H04W 64/00

(52) U.S. Cl. CPC H04W 24/08; H04W 24/02; H04W 64/00

(57) ABSTRACT

Mechanisms for estimating a ratio of indoor-to-outdoor traffic or user equipment distribution. A method is performed by a network node. The method includes obtaining, for a set of user equipment, radio signal measurements. The radio signal measurements have a probability distribution function. The method includes separating the probability distribution function into a set of clusters. Each cluster has its own individual probability distribution function. The method includes estimating the ratio of indoor-to-outdoor traffic or user equipment distribution by predicting, from the individual probability distribution functions of the clusters, which, if any, of the clusters represent indoor user equipment and which, if any, of the clusters represent outdoor user equipment. The method includes performing a network related action in accordance with the ratio of indoor-to-outdoor traffic or user equipment distribution.

### TECHNICAL FIELD

Embodiments presented herein relate to a method, a network node, a computer program, and a computer program product for estimating a ratio of indoor-to-outdoor traffic or user equipment distribution.

### BACKGROUND

In communications networks, there may be a challenge to obtain good performance and capacity for a given communications protocol, its parameters and the physical environment in which the communications network is deployed.

One parameter in providing good performance and capacity for a given communications protocol in a communications network concerns identification of whether a user equipment served by the network, or even a set of such user equipment, is located indoors or outdoors.

In this respect, reliable identification whether user equipment of a mobile communications network are located outdoors or indoors is a non-trivial task. Amid the lack of real data, typically a fixed ratio of 70%-80% indoor users is assumed (i.e., 70%-80% of all user equipment are assumed to be indoors). Information regarding the distribution of indoor versus outdoor users as well as generated traffic in a given environment could be a used as input to network related actions to be performed in the communication network.

One non-limiting example of network related actions is adaptation of network parameters for better Quality-of-Service (QoS). In this respect, fifth generation telecommunication systems (commonly referred to as 5G systems) might be configured to operate at comparatively high carrier frequencies, such as FR2 (frequency range 2) bands in the mm-wave spectrum. For mm-wave frequencies, the attenuation losses of the signals penetrating through the outer walls of a building might be comparatively high compared to legacy telecommunication systems. In such scenarios, information of whether user equipment are indoors or outdoors might provide input to mobile network operators of how to tackle capacity bottlenecks; either by deploying indoor small cells (if the user equipment are indoors) or outdoor (radio) access network nodes (if the user equipment are outdoors).

Most traditional techniques for determining whether user equipment of a mobile communications network are located outdoors or indoors are based on assumptions or surveys that users tend to spend a majority of the time indoors. This is one motivation behind the above noted assumption of 70%-80% indoor users.

U.S. Pat. No. 9,654,935 B2 discloses a method and apparatus for deriving indoor/outdoor classification information for call data for a wireless communication network. A physical channel measurement threshold value is determined and based on comparison with this value a call record is classified as indoor or outdoor. Further, based on RSCP (radio signal code power) measurements, a traffic analyzer system is proposed to find how much traffic is indoors and how much is outdoors.

However, there is still a need for an improved identification of whether a user equipment served by the network, or even a set of such user equipment, is located indoors or outdoors.

### SUMMARY

An object of embodiments herein is to address the above issues and provide a reliable classification of whether user equipment served in a network are indoors or outdoors.

According to a first aspect there is presented a method for estimating a ratio of indoor-to-outdoor traffic or user equipment distribution. The method is performed by a network node. The method comprises obtaining, for a set of user equipment, radio signal measurements. The radio signal measurements have a probability distribution function. The method comprises separating the probability distribution function into a set of clusters. Each cluster has its own individual probability distribution function. The method comprises estimating the ratio of indoor-to-outdoor traffic or user equipment distribution by predicting, from the individual probability distribution functions of the clusters, which, if any, of the clusters represent indoor user equipment and which, if any, of the clusters represent outdoor user equipment. The method comprises performing a network related action in accordance with the ratio of indoor-to-outdoor traffic or user equipment distribution.

According to a second aspect there is presented a network node for estimating a ratio of indoor-to-outdoor traffic or user equipment distribution. The network node comprises processing circuitry. The processing circuitry is configured to cause the network node to obtain, for a set of user equipment, radio signal measurements. The radio signal measurements have a probability distribution function. The processing circuitry is configured to cause the network node to separate the probability distribution function into a set of clusters. Each cluster has its own individual probability distribution function. The processing circuitry is configured to cause the network node to estimate the ratio of indoor-to-outdoor traffic or user equipment distribution by predicting, from the individual probability distribution functions of the clusters, which, if any, of the clusters represent indoor user equipment and which, if any, of the clusters represent outdoor user equipment. The processing circuitry is configured to cause the network node to perform a network related action in accordance with the ratio of indoor-to-outdoor traffic or user equipment distribution.

According to a third aspect there is presented a network node for estimating a ratio of indoor-to-outdoor traffic or user equipment distribution. The network node comprises an obtain module configured to obtain, for a set of user equipment, radio signal measurements. The radio signal measurements have a probability distribution function. The network node comprises a separate module configured to separate the probability distribution function into a set of clusters. Each cluster has its own individual probability distribution function. The network node comprises an estimate module configured to estimate the ratio of indoor-to-outdoor traffic or user equipment distribution by predicting, from the individual probability distribution functions of the clusters, which, if any, of the clusters represent indoor user equipment and which, if any, of the clusters represent outdoor user equipment. The network node comprises an action module configured to perform a network related action in accordance with the ratio of indoor-to-outdoor traffic or user equipment distribution.

According to a fourth aspect there is presented a computer program for estimating a ratio of indoor-to-outdoor traffic or user equipment distribution, the computer program comprising computer program code which, when run on a network node, causes the network node to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide reliable classification of whether user equipment served in a network are indoors or outdoors.

Advantageously, these aspects do not require any separate special-purpose measurements since radio signal measurements are already available in the network.

Advantageously, these aspects do not require any surveys or walk tests.

Advantageously, these aspects can be replicated and rescaled for any type of deployment scenario for any region.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 is a flowchart of methods according to embodiments;

FIG. 3 schematically illustrates probability distribution functions according to an embodiment;

FIG. 4 schematically illustrates a block diagram according to an embodiment;

FIG. 5 schematically illustrates a block diagram according to an embodiment;

FIG. 6 is a schematic diagram showing functional units of a network node according to an embodiment;

FIG. 7 is a schematic diagram showing functional modules of a network node according to an embodiment; and

FIG. 8 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As noted above there is still a need for an improved identification of whether a user equipment served by the network, or even a set of such user equipment, is located indoors or outdoors.

The inventors of the herein disclosed embodiments have realized that the purpose of most existing technologies pertains to classifying whether user equipment engaging in a traditional voice calls are indoors or outdoors. This classification does thus not consider user equipment engaging in general data consumption. With changing user behavior from pure voice services towards general data consumption, more advanced techniques are therefore needed. Further in this respect, traditional techniques to predict the indoor-outdoor ratio of traffic or user equipment based on surveys or assumptions have their own limitations. Commonly, such surveys are expensive to conduct and may have biases resulting in a skewed outcome. Moreover, even if the results are satisfactory, the results might not be applicable for other regions of the network. For example, the results of survey from an urban scenario of a network deployed in Europe may not be applicable to an urban scenario of a network deployed in Asia, or vice versa. Furthermore, within same geographical region there might be differences between urban scenarios, dense urban scenarios, suburban and/or rural scenarios. This might necessitate expensive surveys to be conducted for several scenarios and in several regions.

The inventors of the herein disclosed embodiments have further realized that existing techniques that rely on just RSSI or RSRP/RSCP based measurement for classifying whether user equipment are indoors or outdoors may not correctly capture if a user equipment indeed is indoors or outdoors. For example, a user equipment located outdoors that is in radio shadow may have same RSSI/RSRP value as a user equipment located indoors. This in turn will result in a poor classification. Some existing techniques rely on that dedicated positioning signals are received only outdoors and not indoors. However, dedicated positioning signals alone cannot always correctly capture if a user equipment indeed is indoors or outdoors. For example, a user equipment located indoors close to a window may still receive dedicated positioning signals and a user equipment located outdoors in a dense urban environment may not receive dedicated positioning signals, or may receive dedicated positioning signals only with low quality, causing the location accuracy of the user equipment to be low.

One object of the herein disclosed embodiments is to enable accurate estimation of the ratio of indoor-to-outdoor traffic or user equipment distribution only based on already available measurements.

The embodiments disclosed herein in particular relate to mechanisms for estimating a ratio of indoor-to-outdoor traffic or user equipment distribution. In order to obtain such mechanisms there is provided a network node, a method performed by the network node, a computer program product comprising code, for example in the form of a computer program, that when run on a network node, causes the network node to perform the method.

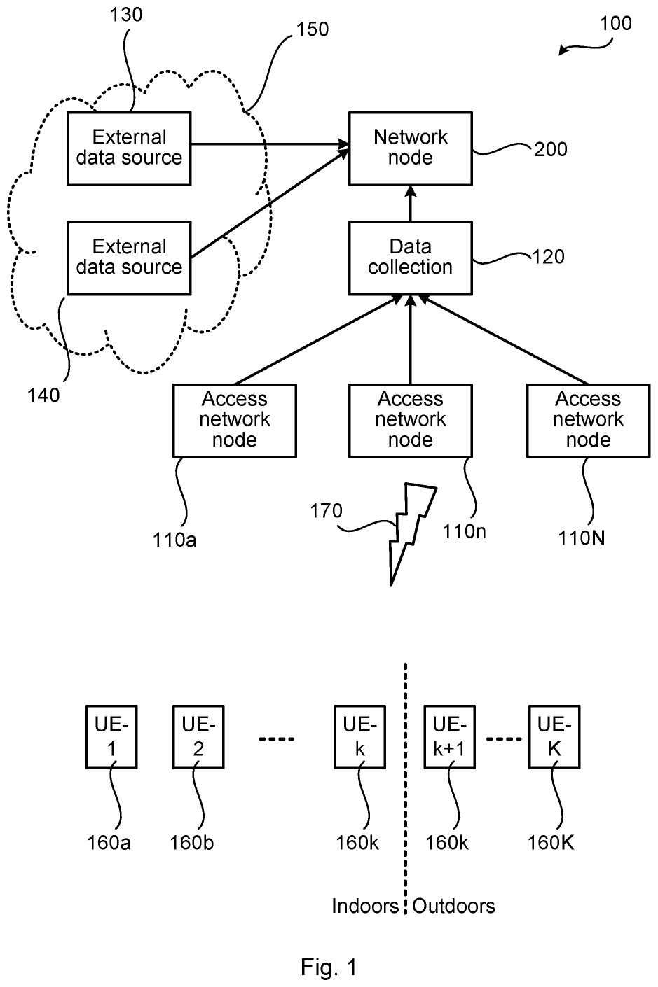

FIG. 1 is a schematic diagram illustrating a communication network 100 where embodiments presented herein can be applied. The communication network 100 comprises (radio) access network nodes 110a, 110n, 110N, such as radio base stations base transceiver stations node Bs (NBs), evolved node Bs (eNBs), gNBs, access points, integrated access and backhaul nodes, or any combination thereof. The (radio) access network nodes 110a:110N are configured to provide network access (as represented by arrow 170) to user equipment 160a, 160b, 160k, 160k+1, 160K, such as portable wireless devices, mobile stations, mobile phones, handsets, wireless local loop phones, smartphones, laptop computers, tablet computers, network equipped vehicles, network equipped sensors, Internet-of-Things (IoT) devices, or any combination thereof.

Radio signal measurements of the wireless links between the (radio) access network nodes 110a:110N and the user equipment 160a:160K are collected by a data collection module 120 and provided to a network node 200 for analysis. As will be further disclosed below, the network node 200 is configured for estimating a ratio of indoor-to-outdoor traffic or user equipment distribution of the user equipment 160a:160K based on the radio signal measurements. As will be further disclosed below, the network node 200 might also make use of further data, as in FIG. 1 represented by external data sources 130, 14 which might be provided in a computational cloud 150.

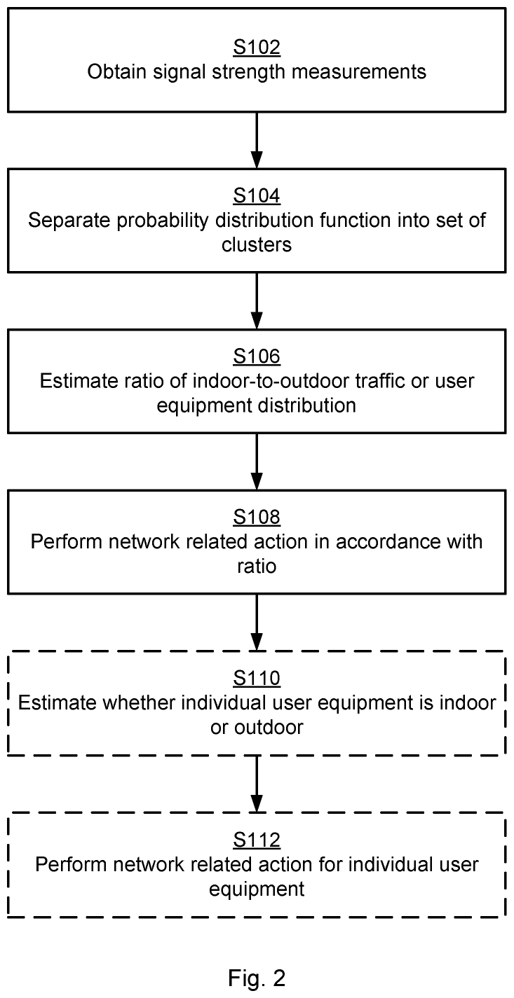

FIG. 2 is a flowchart illustrating embodiments of methods for estimating a ratio of indoor-to-outdoor traffic or user equipment distribution. The methods are performed by the network node 200. The methods are advantageously provided as computer programs 820.

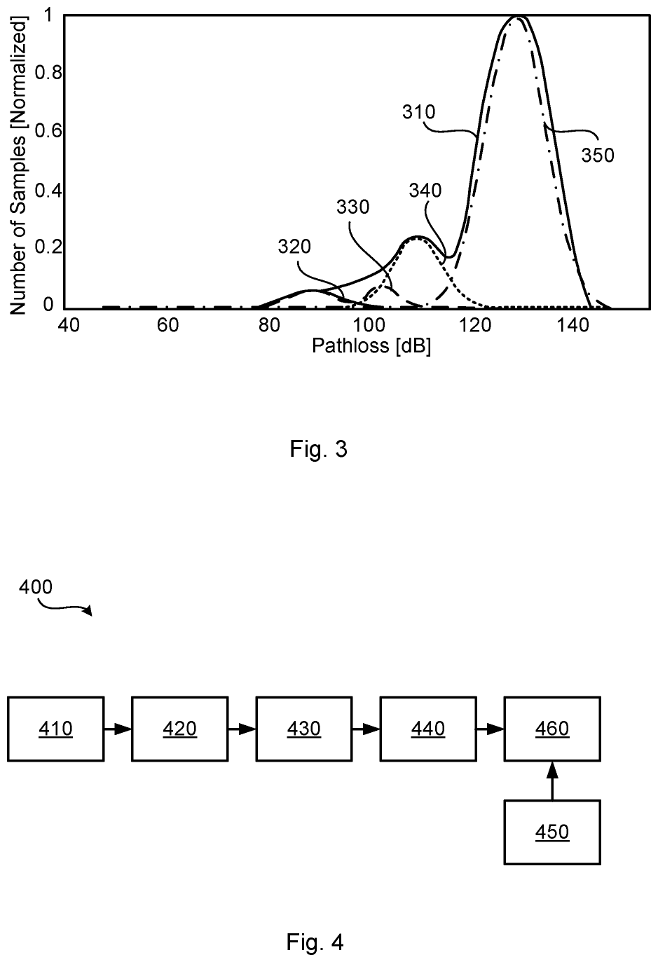

Parallel reference is made to FIG. 3 which shows an example of normalized number of samples as function of pathloss, in dB, for radio signal measurements in terms of pathloss values obtained for a set of user equipment 160a:160K. However, as will be further disclosed below, also other types of radio signal measurements are possible. S102: The network node 200 obtains, for a set of user equipment 160a:160K, radio signal measurements. The radio signal measurements have a probability distribution function 310. Examples of radio signal measurements will be provided below.

S104: The network node 200 separates the probability distribution function 310 into a set of clusters. Each cluster has its own individual probability distribution function 320:350. In the illustrative example of FIG. 3, there are four such individual probability distribution functions 320, 330, 340, 350.

S106: The network node 200 estimates the ratio of indoor-to-outdoor traffic or user equipment distribution by predicting, from the individual probability distribution functions 320:350 of the clusters, which, if any, of the clusters represent indoor user equipment 160a:160k and which, if any, of the clusters represent outdoor user equipment 160k+1:160K. Different examples of how such a prediction can be made will be disclosed below.

S108: The network node 200 performs a network related action in accordance with the ratio of indoor-to-outdoor traffic or user equipment distribution. Different examples of such network related actions will be disclosed below.

This is an efficient way to accurately estimate indoor-outdoor data and user traffic ratio using available network measurement data in terms of radio signal measurements.

Embodiments relating to further details of estimating a ratio of indoor-to-outdoor traffic or user equipment distribution as performed by the network node 200 will now be disclosed.

In some aspect, each user equipment can be labelled as being indoor or outdoor. That is, in some embodiments, the network node 200 is configured to perform (optional) step S110:

S110: The network node 200 estimates whether an individual user equipment 160k in the set of user equipment 160a:160K is indoor or outdoor using the prediction of which, if any, of the clusters represent indoor user equipment 160a:160k and which, if any, of the clusters represent outdoor user equipment 160k+1:160K.

A network related action can then be performed per user equipment. That is, in some embodiments, the network node 200 is configured to perform (optional) step S112:

S112: The network node 200 performs a network related action for the individual user equipment 160a:160k in accordance with whether the individual user equipment 160k is estimated to be indoor or outdoor.

There may be different ways for the network node 200 to separate the probability distribution function 310 into a set of clusters, as in step S104. Different embodiments relating thereto will now be described in turn.

In some aspects, the separation is in step S104 made by means of Gaussian mixture analysis. Further details relating to when the separation is in step S104 made by means of Gaussian mixture analysis will now be disclosed with reference to the block diagram 400 of FIG. 4. According to FIG. 4, a probability distribution function of the radio signal measurements is obtained by a PDF module 410. A GMM module 42o is applied to perform Gaussian mixture modelling on the probability distribution function. A separation module 43o is then applied to identify individual probability distribution functions based on the Gaussian mixture modelling. If needed, an optional converter block 440 is applied to transform the individual probability distribution functions of one type of radio signal measurements to individual probability distribution functions of another type of radio signal measurements (e.g., from pathloss values to RSRP values). Threshold values for the type of radio signal measurements under consideration are obtained from a threshold module 450. A comparison block 460 is then applied to, based on the individual probability distribution functions and the threshold values, estimate the ratio of indoor-to-outdoor traffic or user equipment distribution, as in step S1o6. A transformation from individual probability distribution functions in terms of pathloss values to individual probability distribution functions in terms of RSRP values could be performed based on the power of cell-specific reference signals (CRSs).

In some embodiments, the probability distribution function 310 is separated into the set of clusters by mixture modelling of the probability distribution function 310. The probability distribution function 310 can be separated into different clusters belonging to the same distribution, for example, Gaussian or Log-normal. Further, according to the mixture modelling, each of the clusters has a mixing proportion, where the mixing proportions of all the clusters sums to 1. The ratio of indoor-to-outdoor traffic or user equipment distribution might then be given by a ratio of a sum of all the mixing proportions of any of the clusters representing indoor user equipment 160a:160k and a sum of all the mixing proportions of any of the clusters representing outdoor user equipment 160k+1:160K.

In some examples, the (Gaussian or Log-normal) mixture modelling is performed on radio signal measurements in terms of performance management (PM) counters. Non-limiting examples of will be provided below. Radio signal measurements might be collected by mobile network operators for performance management, evaluation, or for testing purpose. As such, the radio signal measurements lack a direct mapping to the ratio of indoor-to-outdoor traffic or user equipment distribution. According to herein disclosed embodiments, radio signal measurements can be mapped to indoor-outdoor traffic as well as the user ratio. In this respect, the (Gaussian or Log-normal) mixture modelling of the radio signal measurements results in different (Gaussian or Log-normal) clusters with each cluster having its own statistics, in terms of mean and median values, standard deviation, mixing proportion, etc. At least some of the herein disclosed embodiments are based on that the radio signal measurements of the different cluster of user equipment, e.g., located deep within building, located close to windows, located outdoors but close to the (radio) access network node, or outdoors at some distance from the (radio) access network node, etc., are assumed to be Gaussian distributed, and that the probability distribution function 310 is superposition of all these individual probability distribution functions 320:350.

Applying (Gaussian or Log-normal) mixture modelling will split the probability distribution function 310 into several of these clusters, each representing one of the individual probability distribution functions 320:350, where each cluster thus has its own statistics. Particularly, in some embodiments, each of the individual probability distribution functions 320:350 of the clusters has a statistical measure (as given by the statistics), and whether a given cluster of the clusters represents indoor user equipment 160a:160k or outdoor user equipment 160k+1:160K depends on whether the statistical measure for this given cluster satisfy a criterion or not.

As a non-limiting example, with knowledge of statistics of indoor user equipment 160a:160k or outdoor user equipment 160k+1:160K (that can itself be calculated from crowd source data or simulation, as stored in the external data source 130, 140), a prediction can be made which clusters represent indoor user equipment 160a:160k and which clusters represent outdoor user equipment 160k+1:160K. In particular, in some embodiments, the statistical measure is a mean or a median value, and where whether a given cluster of the clusters represents indoor user equipment 160a:160k or outdoor user equipment 160k+1:160K depends on whether the mean or median value for this given cluster is above or below a threshold value.

As a non-limiting example, assume that all user equipment in the external data source 130, 140 that have their battery status as charging or full are examples of user equipment that are located indoors. The mean or median value and standard deviation of the radio signal measurements of such user equipment can then be calculated and be uses as a basis for the criterion.

As a non-limiting example, letting the radio signal measurements be represented by RSRP values, user equipment k with a mean RSRP value of μ_{k,UE,RSRP} is classified to be indoors if:

μ_{k,UE,RSRP}≤μ_{indoor,RSRP}+α_{RSRP}·σ_{indoor,RSRP},

where all measurements are in dBm, and where μ_{indoor,RSRP}, σ_{indoor,RSRP} are the mean value and the standard deviation of the RSRP of indoor user equipment, as e.g. found with battery status as charging or from network simulation of the same area. The value of the parameter α_{RSRP}>0 can be calculated empirically.

As another non-limiting example, letting the radio signal measurements be represented by pathloss values, user equipment k with a mean pathloss value of μ_{k,UE,PL} is classified to be indoors if:

μ_{k,UE,PL}≥μ_{indoor,PL}−α_{PL}·σ_{indoor,PL},

where all measurements are in dB, and where μ_{indoor,PL}, σ_{indoor,PL} are the mean value and the standard deviation of the pathloss of indoor user equipment, as e.g. found with battery status as charging or from network simulation of the same area. The value of the parameter α_{PL}>0 can be calculated empirically.

Taking into account the mixing proportion of which clusters represent indoor user equipment and which clusters represent outdoor user equipment will yield the ratio of indoor-to-outdoor traffic or user equipment distribution. That is, once the decision is made regarding which clusters represent indoor user equipment and which clusters represent outdoor user equipment, the mixing proportion of all the clusters that have been predicated to represent indoor (or outdoor) user equipment can be summed together to get the indoor (or outdoor) traffic and/or user ratio.

As a non-limiting example, assume radio signal measurements having a probability distribution function 310 and that the probability distribution function 310 is separated into a set of four clusters where each cluster has its own individual probability distribution function 320:350 as in FIG. 3. Further, let the mean value of the pathloss for each cluster be μ_{1,PL}, μ_{2,PL}, μ_{3,PL}, μ_{4,PL}, and mixing proportion of these clusters be p₁, p₂, p₃, and p₄, respectively, such that p₁+p₂+p₃+p₄=1. The mean pathloss values are converted to RSRP values, where the mean RSRP values of the clusters are denoted μ_{1,RSRP}, μ_{2,RSRP}, μ_{3,RSRP}, μ_{4,RSRP}, respectively. Further, as above, let

μ_{indoor,RSRP}, σ_{indoor,RSRP} be the mean value and the standard deviation of the RSRP of indoor user equipment. Then, if the cluster with the individual probability distribution function 350 satisfies: μ_{4,RSRP}≤μ_{indoor,RSRP}+α_{RSRP}·σ_{indoor,RSRP}, then this cluster represent indoor user equipment, whilst the remaining clusters represent outdoor user equipment. The indoor traffic is then given by p₄ and outdoor traffic is given by p₂+p₃+p₄.

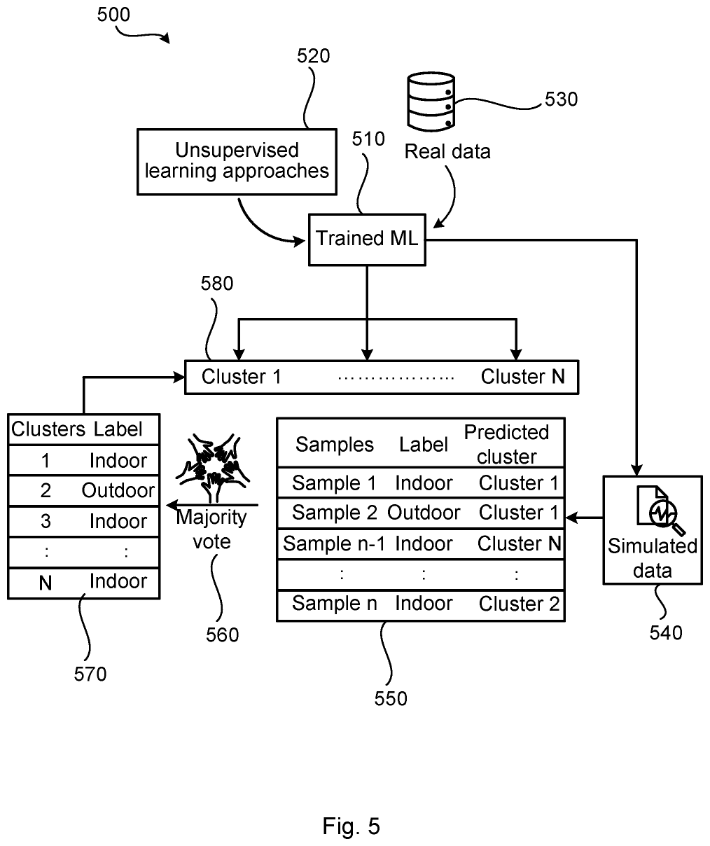

In some aspects, the separation is in step S104 made by means of machine learning using an unsupervised clustering methodology. Further details relating to when the separation is in step S104 made by means of machine learning using an unsupervised clustering methodology will now be disclosed with reference to the block diagram 500 of FIG. 5.

In some embodiments, the probability distribution function 310 is separated into the set of clusters by machine learning using an unsupervised clustering methodology of the probability distribution function 310. Any unsupervised clustering methodology, as provided by an unsupervised learning approaches block 520, can be used to separate the probability distribution function 310 into clusters 580 by the machine learning block 510. In some examples, a Gaussian mixture model or a Log-normal mixture model is used as the unsupervised clustering methodology. That is, in some embodiments, the unsupervised clustering methodology is a Gaussian mixture model or a Log-normal mixture model. Without loss of generality, a Gaussian mixture model or a Log-normal mixture model is used as clustering methodology, and RSRP, user equipment speed, battery status, and throughput are used as features of the Gaussian mixture model or the Log-normal mixture model. Values of the RSRP, user equipment speed, battery status, and throughput can be provided in terms of simulated data 540 or live measurements 530.

Whether a given cluster of the clusters represent indoor user equipment 160a:160k or outdoor user equipment 160k+1:160K might then depend on a majority vote 560 of samples obtained from a dataset. The trained machine learning model can be applied to predict to which clusters each of the radio signal measurements belong to 580. Having the pair {indoor/outdoor label, cluster number} for each radio signal measurement 550, each of the obtained clusters can be labelled using the majority vote of the indoor/outdoor labels inside each of the clusters 560. Each radio signal measurement can be labelled according to the label of the cluster it belongs to 570. Such a machine learning model can be executed on a user equipment which may then report its status (indoor or outdoor) to its serving (radio) access network node.

In some non-limiting examples, a learning model is developed in an unsupervised way that label a user equipment as belonging to either a cluster representing indoor user equipment or a cluster representing outdoor user equipment. In order to do so, radio signal measurements, possible in combination with connection test data or any other test data, for example, RSRP, device speed, battery status, etc., can be used. When applying unsupervised learning approach, the real data space can be divided into several clusters. Using the prediction of the simulated or relevant measured data, each such cluster can then be labelled as representing indoor user equipment or representing outdoor user equipment. Then, each user equipment of each cluster can be labeled as being either an indoor user equipment or an outdoor user equipment.

As noted above, there could be different examples of radio signal measurements. In some non-limiting examples, each of the radio signal measurements is a signal strength measurement, such as an RSRP value or a pathloss value. Measurements of path gain or received signal level (RxSignalLevel), received signal code power (RSCP) or received signal strength indicator (RSSI) could be used for this purpose. In some examples, for the calculation of traffic ratio, the Gaussian mixture model or Log-normal mixture model uses radio signal measurements in terms of RSRP values whereas for user location (indoor or outdoor) ratio estimation, the Gaussian mixture model or Log-normal mixture model uses radio signal measurements in terms of RSRP values or pathloss values. The radio signal measurements could be simulated measurements, live measurements, or any combination thereof. In some aspects, also values of other parameters are used. Particularly, in some embodiments, the ratio of indoor-to-outdoor traffic or user equipment distribution further is estimated based on at least one of: user equipment speed, user equipment battery status, throughput, positioning availability, location accuracy, timing advance measurements of the set of user equipment 160a:160K. In this respect, timing advance measurement may be used to refine the classification. As indoor user equipment are typically facing wall attenuation losses from outdoor to indoor propagation, the average pathloss for indoor user equipment will be larger than that of outdoor user equipment with the same distance to the serving (radio) access network node. As distance can be translated to propagation time of an electromagnetic wave, the timing advance measurements provide some means to estimate the distance between a user equipment and its serving (radio) access network node.

There could be different applications of the herein disclosed embodiments.

In some aspects, the herein disclosed embodiments are applied on a per cell basis. That is, in some embodiments, all user equipment 160a:160K in the set of user equipment 160a:160K are served in one and the same cell.

In some aspects, the herein disclosed embodiments are applied on a network region basis. That is, in some embodiments, all user equipment 160a:160K in the set of user equipment 160a:160K are served in one and the same subnetwork.

In some aspects, the herein disclosed embodiments are applied per mobile network operator basis. That is, in some embodiments, all user equipment 160a:160K in the set of user equipment 160a:160K are served by one and the same mobile network operator.

In some aspects, the herein disclosed embodiments are applied per frequency band. That is, in some embodiments, all user equipment 160a:160K in the set of user equipment 160a:160K operate in one and the same frequency band. In other aspects, the herein disclosed embodiments are applied on different frequency band data.

In some aspects, the herein disclosed embodiments are applied at a reference frequency band for the user equipment by compensating for frequency dependent losses and bringing the radio signal measurements at a reference frequency. For example, assume that one set of the user equipment is served at frequency band f1 and another set of the user equipment is served at frequency band f2, and the herein disclosed embodiment are to be applied at a reference frequency band f_ref. Taking RSRP, in dBm, as a non-limiting example of the radio signal measurements, the measured RSRP value at frequency band f1, denoted RSRP_f1, and the measured RSRP value at frequency band f2, denoted RSRP_f2, can be compensated according to: RSRP_fref_f1=RSRP_f1+20·log10(f1/f_ref) and RSRP_fref_f2=RSRP_f2+20*log10(f2/f_ref). Now both RSRP_fref_f1 and RSRP_fref_f2 are compensated and is at reference frequency f_ref. Thereby the herein disclosed embodiments can be applied at reference frequency for both the sets of user equipment as accumulated together. Also other frequency dependent losses can be compensated in the same manner. The herein disclosed embodiments could thereby also be applied to communication networks serving multiple frequency bands.

There could be different examples of network related actions performed in step S108 and step S112. In some non-limiting examples, the network related action pertains to at least one of: adaptation mobile network resources, network deployment, user behaviour contextualization. The information of ratio of indoor-to-outdoor traffic or user equipment distribution could thus be a used as input for network deployment. Further, the information at the (radio) access network node that a user equipment is indoors or outdoors can be used for improving quality-of-service (QoS) and/or quality-of-experience (QoE) by the (radio) access network node adapting mobile network resources accordingly. information of ratio of indoor-to-outdoor traffic or user equipment distribution can also be used for user behavior contextualization which can in turn be used for learning user behaviour.

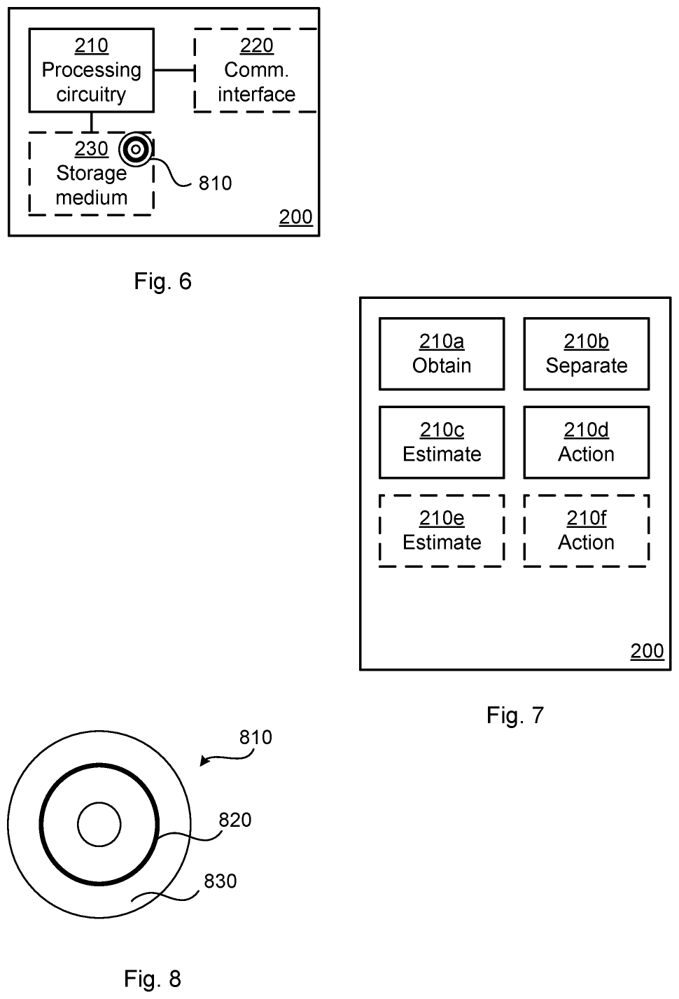

FIG. 6 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 810 (as in FIG. 8), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network node 200 may further comprise a communications interface 220 at least configured for communications with other entities, functions, nodes, and devices, as in the communication network 100 of FIG. 1. As such the communications interface 220 may comprise one or more transmitters and receivers, comprising analogue and digital components. The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 7 schematically illustrates, in terms of a number of functional modules, the components of a network node 200 according to an embodiment. The network node 200 of FIG. 7 comprises a number of functional modules; an obtain module 210a configured to perform step S102, a separate module 210b configured to perform step S104, an estimate module 210C configured to perform step S106, and an action module 210d configured to perform step S108. The network node 200 of FIG. 7 may further comprise a number of optional functional modules, such as any of an estimate module 210e configured to perform step S110, and an action module 210f configured to perform step S112.

In general terms, each functional module 210a:210f may in one embodiment be implemented only in hardware and in another embodiment with the help of software, i.e., the latter embodiment having computer program instructions stored on the storage medium 230 which when run on the processing circuitry makes the network node 200 perform the corresponding steps mentioned above in conjunction with FIG. 7. It should also be mentioned that even though the modules correspond to parts of a computer program, they do not need to be separate modules therein, but the way in which they are implemented in software is dependent on the programming language used. Preferably, one or more or all functional modules 210a:210f may be implemented by the processing circuitry 210, possibly in cooperation with the communications interface 220 and/or the storage medium 230. The processing circuitry 210 may thus be configured to from the storage medium 230 fetch instructions as provided by a functional module 210a:210f and to execute these instructions, thereby performing any steps as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time.

Thus, a first portion of the instructions performed by the network node 200 may be executed in a first device, and a second portion of the of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 6 the processing circuitry 210 may be distributed among a plurality of devices, or nodes. The same applies to the functional modules 210a:210f of FIG. 7 and the computer program 820 of FIG. 8.

FIG. 8 shows one example of a computer program product 810 comprising computer readable storage medium 830. On this computer readable storage medium 830, a computer program 820 can be stored, which computer program 820 can cause the processing circuitry 210 and thereto operatively coupled entities and devices, such as the communications interface 220 and the storage medium 230, to execute methods according to embodiments described herein. The computer program 820 and/or computer program product 810 may thus provide means for performing any steps as herein disclosed.

In the example of FIG. 8, the computer program product 810 is illustrated as an optical disc, such as a CD (compact disc) or a DVD (digital versatile disc) or a Blu-Ray disc. The computer program product 810 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 820 is here schematically shown as a track on the depicted optical disk, the computer program 820 can be stored in any way which is suitable for the computer program product 810.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for estimating a ratio of indoor-to-outdoor traffic or user equipment distribution, the method being performed by a network node, the method comprising:
obtaining, for a set of user equipment, radio signal measurements, the radio signal measurements having a probability distribution function;
separating the probability distribution function into a set of clusters, each cluster having its own individual probability distribution function;
estimating the ratio of indoor-to-outdoor traffic or user equipment distribution by predicting, from the individual probability distribution functions of the clusters, which, if any, of the clusters represent indoor user equipment and which, if any, of the clusters represent outdoor user equipment; and
performing a network related action in accordance with the ratio of indoor-to-outdoor traffic or user equipment distribution.

2. The method according to claim 1, wherein the method further comprises:
estimating whether an individual user equipment in the set of user equipment is indoor or outdoor using the prediction of which, if any, of the clusters represent indoor user equipment and which, if any, of the clusters represent outdoor user equipment; and
performing a network related action for the individual user equipment in accordance with whether the individual user equipment is estimated to be indoor or outdoor.

3. The method according to claim 1, wherein the probability distribution function is separated into the set of clusters by mixture modelling, such as Gaussian mixture modelling or Log-normal mixture modelling, of the probability distribution function.

4. The method according to claim 3, wherein each of the clusters has a mixing proportion, wherein the mixing proportions of all the clusters sums to 1, and wherein the ratio of indoor-to-outdoor traffic or user equipment distribution is given by a ratio of a sum of all the mixing proportions of any of the clusters representing indoor user equipment and a sum of all the mixing proportions of any of the clusters representing outdoor user equipment.

5. The method according to claim 3, wherein each of the individual probability distribution functions of the clusters has a statistical measure, and wherein whether a given cluster of the clusters represents indoor user equipment or outdoor user equipment depends on whether the statistical measure for said given cluster satisfy a criterion or not.

6. The method according to claim 5, wherein the statistical measure is a mean or a median value, and wherein whether said given cluster of the clusters represents indoor user equipment or outdoor user equipment depends on whether the mean or median value for said given cluster is above or below a threshold value.

7. The method according to claim 1, wherein the probability distribution function is separated into the set of clusters by machine learning using an unsupervised clustering methodology of the probability distribution function.

8. The method according to claim 7, wherein the unsupervised clustering methodology is a Gaussian mixture model or a Log-normal mixture model.

9. The method according to claim 7, wherein whether a given cluster of the clusters represent indoor user equipment or outdoor user equipment depends on a majority vote of samples obtained from a dataset.

10. The method according to claim 1, wherein each of the radio signal measurements is a signal strength measurement, such as an RSRP value or a pathloss value.

11. The method according to claim 1, wherein the ratio of indoor-to-outdoor traffic or user equipment distribution further is estimated based on at least one of: user equipment speed, user equipment battery status, throughput, positioning availability, location accuracy, timing advance measurements of the set of user equipment.

12. The method according to claim 1, wherein all user equipment in the set of user equipment are served in one and the same cell.

13.-16. (canceled)

17. A network node for estimating a ratio of indoor-to-outdoor traffic or user equipment distribution, the network node comprising processing circuitry, the processing circuitry being configured to cause the network node to:
obtain, for a set of user equipment, radio signal measurements, the radio signal measurements having a probability distribution function;
separate the probability distribution function into a set of clusters, each cluster having its own individual probability distribution function;
estimate the ratio of indoor-to-outdoor traffic or user equipment distribution by predicting, from the individual probability distribution functions of the clusters, which, if any, of the clusters represent indoor user equipment and which, if any, of the clusters represent outdoor user equipment; and
perform a network related action in accordance with the ratio of indoor-to-outdoor traffic or user equipment distribution.

18.-19. (canceled)

20. A computer storage medium storing a computer program for estimating a ratio of indoor-to-outdoor traffic or user equipment distribution, the computer program comprising computer code which, when run on processing circuitry of a network node, causes the network node to:
obtain, for a set of user equipment, radio signal measurements, the radio signal measurements having a probability distribution function;
separate the probability distribution function into a set of clusters, each cluster having its own individual probability distribution function;
estimate the ratio of indoor-to-outdoor traffic or user equipment distribution by predicting, from the individual probability distribution functions of the clusters, which, if any, of the clusters represent indoor user equipment and which, if any, of the clusters represent outdoor user equipment; and
perform a network related action in accordance with the ratio of indoor-to-outdoor traffic or user equipment distribution.

21. (canceled)
